(19) United States
(12) Patent Application Publication
(10) Pub. No.: US 2020/0113786 A1
(43) Pub. Date: Apr. 16, 2020

(54) INTERMITTENT ROTARY MACHINE AND RELATED METHOD FOR FILLING CAPSULES WITH PHARMACEUTICAL OR NUTRACEUTICAL PRODUCTS

(71) Applicant: MG2- S.R.L., PIANORO (IT)

(72) Inventors: Ernesto GAMBERINI, RASTIGNANO [BO] (IT); DAVIDE NANNETTI, QUARTO INFERIORE [BO] (IT)

(21) Appl. No.: 16/598,427

(22) Filed: Oct. 10, 2019

(30) Foreign Application Priority Data
Oct. 11, 2018 (IT) 102018000009357

(51) Int. Cl. A61J 3/07; B65B 1/38

(52) U.S. Cl. CPC A61J 3/074; B65B 43/50; B65B 1/38

(57) ABSTRACT

An intermittent rotary machine for filling capsules with pharmaceutical or nutraceutical products is provided with a dosing disc, which delimits a hopper at the bottom for containing a pharmaceutical or nutraceutical powder product and has at least a group of dosing chambers, which are fed first of all through at least one compacting station, in the area of which the product contained in each dosing chamber is compacted by a respective compacting piston, and then through an expulsion station, in the area of which only part of the product contained in each dosing chamber is discharged into a respective capsule by a respective expelling piston.

### CROSS-REFERENCE TO RELATED APPLICATIONS

This patent application claims priority from Italian Patent Application No. 102018000009357 filed on Oct. 11, 2018, the entire disclosure of which is incorporated herein by reference.

### TECHNICAL FIELD

The present invention relates to an intermittent rotary machine for filling capsules with pharmaceutical or nutraceutical products.

### BACKGROUND ART

In the pharmaceutical field, it is known to provide an intermittent rotary machine of the type comprising a dosing drum having a dosing disc, which is mounted so as to rotate in an intermittent manner around a substantially vertical first rotation axis and is provided with at least a group of dosing chambers, which are formed through the dosing disc parallel to the first rotation axis and are fed by the dosing disc around the first rotation axis.

Each dosing chamber has a volume equal to the product of its cross-section and the thickness of the dosing disc.

The dosing drum further comprises a hopper for containing a pharmaceutical or nutraceutical powder product delimited at the bottom by the dosing disc; at least one compacting station provided with a plurality of compacting pistons, which are movable parallel to the first rotation axis so that each one compacts the product contained in a respective dosing chamber; and an expulsion station provided with a plurality of expelling pistons, which are movable parallel to the first rotation axis so that each one discharges into a respective capsule the product contained in a respective dosing chamber.

At each stop of the dosing drum, the compacting pistons and the expelling pistons are moved parallel to the first rotation axis with a straight reciprocating motion comprising a forth stroke and a back stroke.

The machine further comprises a feeding drum having a feeding disc, which is mounted so as to rotate in an intermittent manner around a second rotation axis substantially parallel to the first rotation axis and extends under the dosing disc in the area of the expulsion station.

The feeding disc is provided with a plurality of pockets, each of which is suited to receive and hold, on the inside, a respective capsule and is fed by the feeding disc through the expulsion station.

The machine further comprises a closing plate shaped to close the dosing chambers at the bottom in the area of the compacting stations and to open the dosing chambers at the bottom in the area of the expulsion station.

In order to prevent further product from falling by gravity from the hopper into the dosing chambers and the capsules in the area of the expulsion station at the end of the back stroke of the expelling pistons, thus compromising the correct filling of the capsules, the dosing drum is provided with a shaped diverter block mounted inside the hopper so as to prevent the product from reaching the expulsion station.

The known intermittent rotary machines of the type described above have some drawbacks mainly due to the fact that the filling of the capsules with different quantities of product each time requires the replacement of the dosing disc with a new dosing disc having a different thickness and/or a different cross section of the dosing chambers.

The known intermittent rotary machines of the type described above also have further drawbacks consisting of the following:

the diverter block mounted in the hopper is relatively complex and expensive; and

due to the machining and assembly tolerances of the dosing disc and the closing plate, the product fed into the empty dosing chambers can disperse between the dosing disc and the closing plate and in the external environment and require relatively time-consuming, complex, and expensive operations of washing the machine.

### DISCLOSURE OF INVENTION

The object of the present invention is to provide an intermittent rotary machine for filling capsules with pharmaceutical or nutraceutical products, which is free from the drawbacks described above and simple and inexpensive to implement.

According to the present invention, an intermittent rotary machine for filling capsules with pharmaceutical products is provided as claimed in the claims from 1 to 10.

The present invention further relates to a method for filling capsules with pharmaceutical products.

According to the present invention, a method for filling capsules with pharmaceutical products is provided as claimed in the claims from 11 to 16.

### BRIEF DESCRIPTION OF THE DRAWINGS

The present invention will now be described with reference to the accompanying drawings, which illustrate a non-limiting embodiment thereof, wherein:

FIG. 1 is a schematic plan view, with parts removed for clarity, of a preferred embodiment of the machine of the present invention;

FIG. 2 is a schematic plan view, with parts removed for clarity, of a first detail of the machine in FIG. 1;

FIG. 3 is a schematic side view, with parts in section and parts removed for clarity, of a second detail of the machine in FIG. 1;

FIG. 4 schematically illustrates the principle of operation of the machine in FIG. 1; and

FIG. 5 is a schematic plan view, with parts removed for clarity, of a variant of the machine in FIG. 1.

### BEST MODE FOR CARRYING OUT THE INVENTION

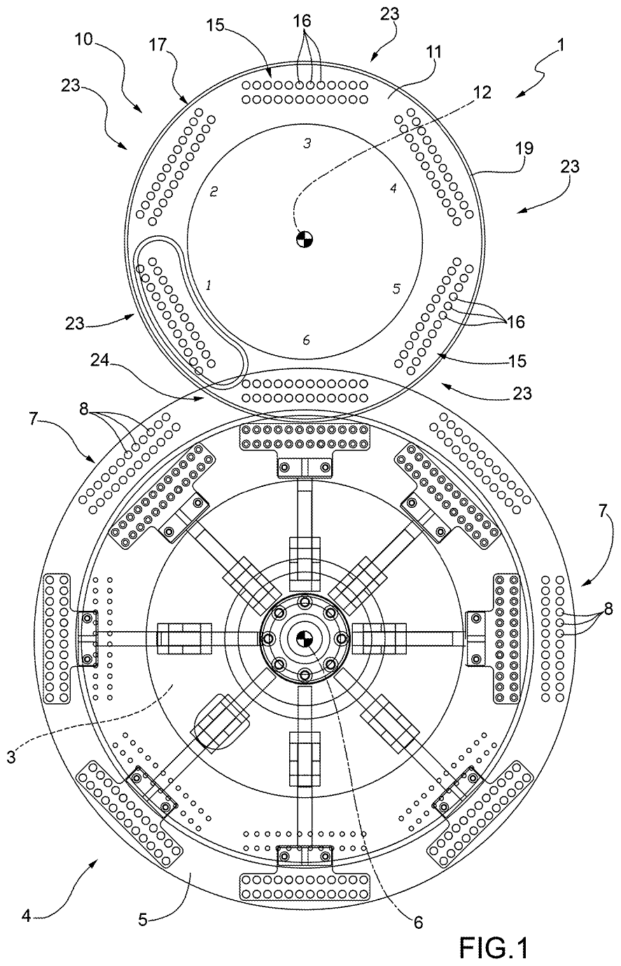

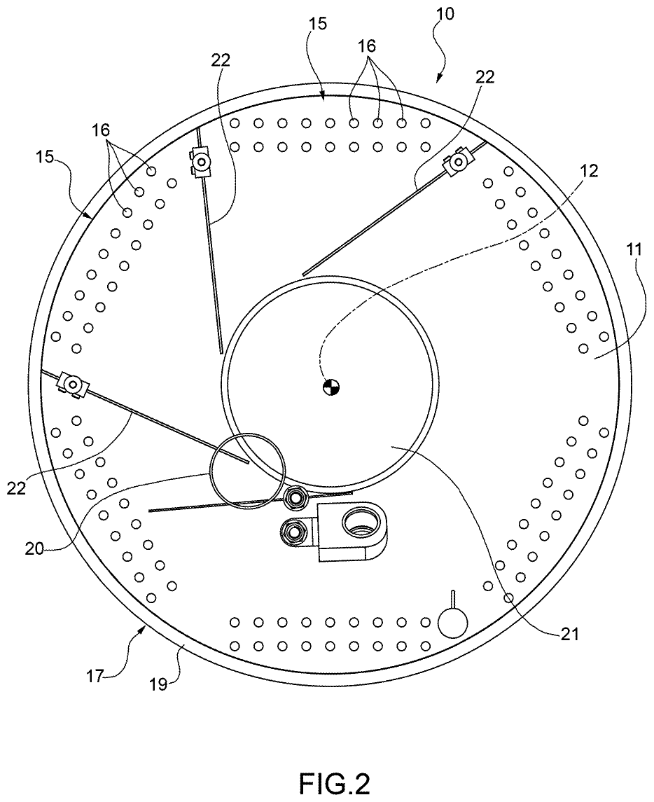

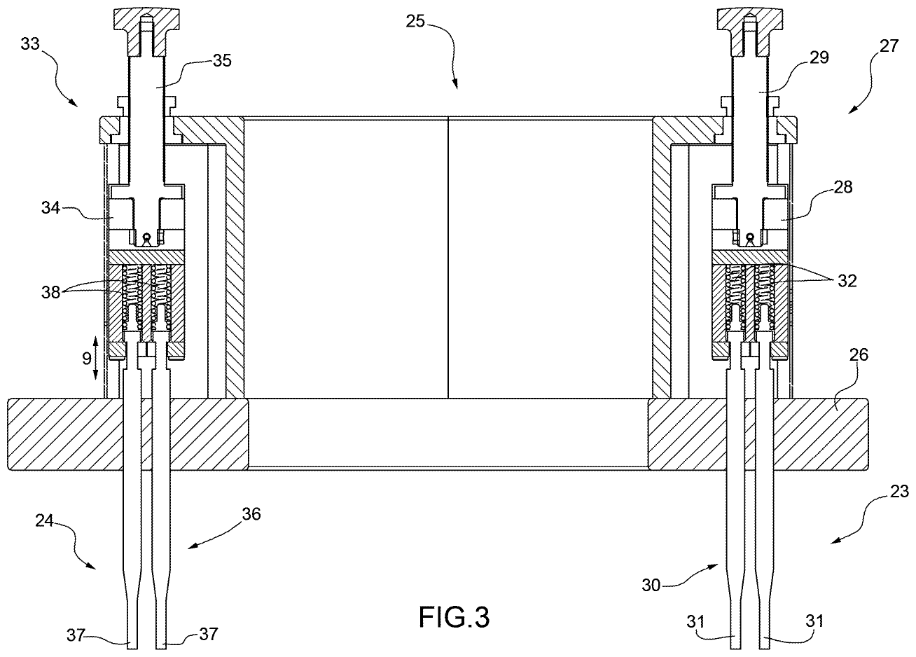

With reference to FIGS. 1 to 4, number 1 indicates, as a whole, an intermittent rotary machine for filling capsules (not shown) with pharmaceutical or nutraceutical products.

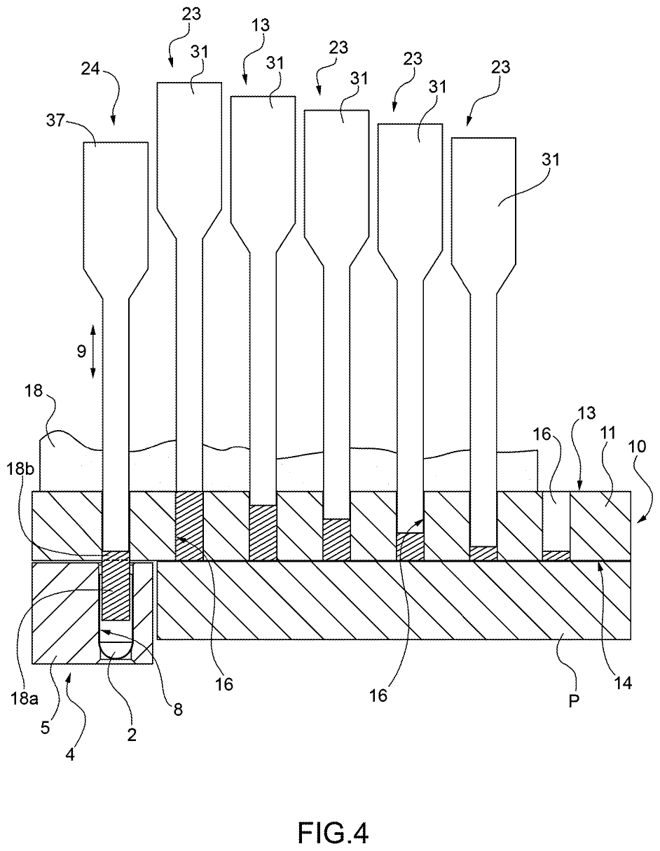

Each capsule (not shown) comprises a bottom member 2 (FIG. 4) and a cap (not shown) for closing the bottom member 2.

The machine 1 comprises a frame 3 and a feeding drum 4 of a known type provided with a feeding disc 5, which is rotatably mounted on the frame 3 so as to rotate in an intermittent manner, relative to the frame 3 and under the thrust of a known and not shown operating device, around a substantially vertical rotation axis 6 orthogonal to the plane of the sheet of FIG. 1.

The disc 5 is provided with a plurality of groups 7 of pockets 8 evenly distributed around the axis 6 along the periphery of the disc 5.

The pockets 8 of each group 7 of pockets 8 are formed through the disc 5 in a vertical direction 9 substantially parallel to the axis 6, each configured to receive and hold a respective bottom member 2 arranged with its concavity facing upwards, and are distributed along two parallel rows transverse to the axis 6.

The machine 1 further comprises a dosing drum 10 provided with a dosing disc 11, which is rotatably mounted on the frame 3 so as to rotate in an intermittent manner, relative to the frame 3 and under the thrust of a known and not shown operating device, around a substantially vertical rotation axis 12 parallel to the axis 6.

The disc 11 is axially delimited by an upper face 13 and a lower face 14, which are substantially flat, opposite and parallel to each other, and is provided with a plurality of groups 15 of dosing chambers 16, which are evenly distributed around the axis 12 along the periphery of the disc 11, and are equal in number to the number of groups 7 of pockets 8.

The chambers 16 of each group 15 of chambers 16 are formed through the disc 11 in direction 9 and distributed along two parallel rows transverse to the axis 12, similarly to the pockets 8.

Each chamber 16 opens outwards at both the face 13 and the face 14 and has a volume equal to the product of its cross-section and a thickness of the disc 11.

The drum 10 further comprises a containment hopper 17, which houses on the inside a pharmaceutical or nutraceutical powder product 18, is delimited at the bottom by the disc 11 so as to allow the chambers 16 to receive the product 18, and is further laterally delimited by a cylindrical wall 19 fixed to the frame 3 coaxially with the axis 12.

The product 18 is fed into the hopper 17 by a feeding duct 20 extending above the disc 11 in direction 9, and is distributed along an annular peripheral portion of the disc 11 by a conical diverter 21 fixed to the disc 11 coaxially with the axis 12 and by means of a plurality of distribution vanes 22 fixed to the wall 19 and arranged inside the hopper 17.

According to a variant not shown, the duct 20 is vibrated to guarantee a better distribution of the product 18 on the disc 11.

The chambers 16 are fed by the disc 11 around the axis 12 through a plurality of compacting stations 23 (in this case five stations 23), in the area of which the product 18 contained in the chambers 16 is compacted, and through an expulsion station 24, in the area of which the disc 11 extends above the disc 5 to allow the discharge of the product 18 into the respective bottom members 2.

The chambers 16 are closed at the bottom by a circular plate P, which is mounted below the disc 11 coaxially with the axis 12, and is unloaded, in the area of the station 24, to allow the disc 5 to be inserted under the disc 11.

The dosing drum 10 is further provided with a compacting and expulsion unit 25 comprising a support plate 26, which has a substantially circular shape, extends around the axis 12 above the hopper 17, and is slidably coupled to the frame 3 in order to perform rectilinear movements, relative to the frame 3 and under the thrust of a pair of known and not shown operating devices, in direction 9 between a raised position and a lowered position.

The unit 25 comprises, for each station 23, a respective compacting assembly 27 comprising, in turn, a slide 28, which is slidably coupled to the plate 26, and is further coupled via a screw-and-nut coupling to an adjustment screw 29, which is rotated manually or by means of an operating device to selectively control the position of the slide 28 relative to the disc 11 in direction 9.

The slide 28 supports a group 30 of compacting pistons 31, which are equal in number to the number of chambers 16 of a group 15 of chambers 16, extend in direction 9, and are each aligned with a respective chamber 16 in direction 9.

The pistons 31 are distributed along two parallel rows transverse to the axis 12, similarly to the chambers 16, and are slidably coupled to the slide 28 in order to perform rectilinear movements, relative to the slide 28, in direction 9.

The movement of each piston 31 relative to the slide in direction 9 is selectively controlled by a shock absorber device, which in this case is defined by a spring 32 interposed between the slide 28 and the piston 31, in order to exert a constant compacting force and thus maintain a constant density of the product 18 in the chambers 16.

According to a variant not shown, the springs 32 are removed and replaced with respective pneumatic shock absorber devices.

The unit 25 further comprises an expelling assembly 33, which is mounted in the station 24 and very similar to the assemblies 27.

Therefore, the assembly 33 comprises a slide 34, which is slidably coupled to the plate 26, and is further coupled via a screw-and-nut coupling to an adjustment screw 35, which is rotated manually or by means of an operating device to selectively control the position of the slide 34 relative to the disc 11 in direction 9.

The slide 34 supports a group 36 of expelling pistons 37, which are equal in number to the number of chambers 16 of a group 15 of chambers 16, extend in direction 9, and are each aligned with a respective chamber 16 in direction 9.

The pistons 37 are distributed along two parallel rows transverse to the axis 12, similarly to the chambers 16, and are slidably coupled to the slide 34 in order to perform rectilinear movements, relative to the slide 34, in direction 9.

The movement of each piston 37 relative to the slide in direction 9 is selectively controlled by a shock absorber device, which in this case is defined by a spring 38 interposed between the slide 34 and the piston 37.

According to a variant not shown, the springs 38 are removed and replaced with respective pneumatic shock absorber devices.

The operation of the machine 1 will now be described with reference to FIG. 4 and to a group 15 of dosing chambers 16.

The group 15 of chambers 16 taken into account is first of all fed in succession by the dosing disc 11 around the axis 12 and through the five compacting stations 23.

At each stop of the disc 11, the plate 26 of the compacting and expulsion unit 25 is lowered in direction 9 to allow the compacting pistons 31 of the station 23, in which the group 15 of chambers 16 is arranged each time, to compact the product 18 contained in the respective chambers 16.

The group 15 of chambers 16 is then fed into the expulsion station 24 matching a group 7 of pockets 8 to allow the expelling pistons 37 to discharge the product 18 contained in the chambers 16 into the respective bottom members 2.

In this regard, it should be pointed out that the position of the slide 34 relative to the disc 11 in the direction 9 is adjusted so as to allow the pistons 37 to discharge into each bottom member 2 only a first portion 18a of the product 18 contained in the respective chamber and to hold in the respective chamber 16 a second portion 18b of the product 18.

In other words, at each stop of the disc 11 around the axis 12, the plate 26, and hence the expelling pistons 37, are moved in direction 9 with a straight reciprocating motion comprising a forth stroke, at the end of which the pistons 37 stop at a given distance from the lower face 14 of the disc 11, and a back stroke.

The subsequent rotation of the disc 11 around the axis causes the separation of the portion 18a from the portion 18b.

Each chamber 16 therefore has a height equal to the sum of the height of the portion 18a and the height of the portion 18b.

The machine 1 has some advantages mainly due to the fact that:

the volume of the portion 18a of product 18 fed into each bottom member 2 can be selectively controlled in a relatively simple and inexpensive manner, avoiding the replacement of the disc 11 each time and adjusting the position of the slide 34, and therefore of the expelling pistons 37, relative to the disc 11 in direction 9;

the portions 18b prevent the falling of new pharmaceutical product 18 into the bottom members 2 when the expelling pistons 37 are disengaged from the respective chambers 16; and

the portions 18b prevent the dispersion of the pharmaceutical product 18 between the feeding disc 5 and the plate P in the external environment.

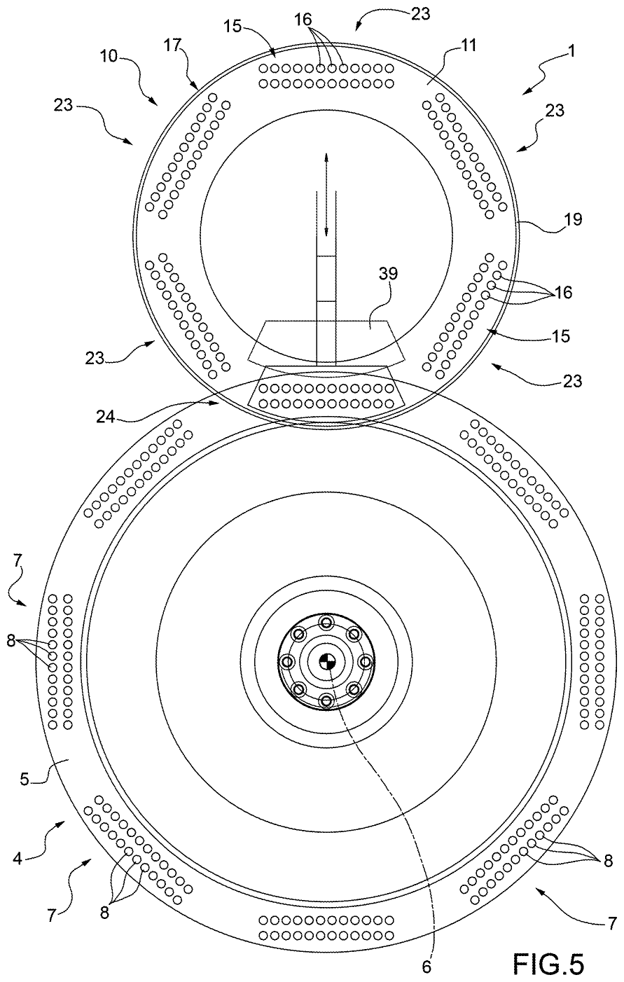

The variant shown in FIG. 5 differs from what is shown in the preceding figures solely in that, therein, the portions 18b are separated from the respective portions 18a by a cutting blade 39, which is mounted in the area of the expulsion station 24 and is movable transversely to the axis 12 between the feeding disc 5 and the dosing disc 11.

According to a variant, not shown, the position of each expelling piston 37 relative to the slide 34 is selectively controlled by an adjustment device according to the position of each chamber 16 relative to the axis 12.

1. An intermittent rotary machine for filling capsules (2) with pharmaceutical or nutraceutical products, the machine comprising a dosing drum (10) comprising, in turn, a dosing disc (11), which is mounted so as to rotate in an intermittent manner around a substantially vertical first rotation axis (12) and is provided with at least a group (15) of dosing chambers (16) obtained through the dosing disc (11) parallel to the first rotation axis (12); a hopper (17) for containing a pharmaceutical or nutraceutical powder product (18), which is delimited at the bottom by the dosing disc (11); at least one compacting station (23), which is provided with a plurality of compacting pistons (31), which are movable parallel to the first rotation axis (12) so that each one compacts the product (18) contained in a respective dosing chamber (16); and an expulsion station (24), which is provided with a plurality of expelling pistons (37), each associated with a respective dosing chamber (16) and movable parallel to the first rotation axis (12) so as to discharge the product (18) into a respective capsule (2); and being characterized in that the expulsion station (24) is further provided with an adjustment device (34, 35) to selectively control the position of the expelling pistons (37) relative to the dosing disc (11) parallel to the first rotation axis (12), so that each expelling piston (37) discharges into the respective capsule (2) only part of the product (18) contained in the respective dosing chamber (16).

2. The machine according to claim 1, wherein the dosing drum (10) comprises an operating device (26) to move the expelling pistons (37) with a straight reciprocating motion comprising a forth stroke and a back stroke.

3. The machine according to claim 2, wherein the adjustment device (34, 35) is configured so as to allow each expelling piston (37) to move along only part of the respective dosing chamber (16) during said forth stroke.

4. The machine according to claim 2, wherein the dosing chambers (16) extend between an upper face (13) and a lower face (14) of the dosing disc (11); the adjustment device (34, 35) being configured to stop the expelling pistons (37) at a given distance from the lower face (14) at the end of the forth stroke.

5. The machine according to claim 1, wherein the dosing drum (10) further comprises a closing plate (P) to close the dosing chambers (16) at the bottom in the area of the compacting stations (23).

6. The machine according to claim 1, wherein, in the area of the expulsion station (24), each dosing chamber (16) houses, on the inside, a first portion (18a) of product (18) suited to be fed into the respective capsule (2) and a second portion (18b) of product (18) suited to be held in the dosing chamber (16); the dosing chamber (16) having a height that is equal to the sum of the heights of said first and said second portion (18a, 18b).

7. The machine according to claim 1, wherein the adjustment device (34, 35) comprises a support slide (34) and operating means (35) to move the support slide (34) relative to the dosing disc (11) parallel to the first rotation axis (12); the expelling pistons (37) being carried by the support slide (34).

8. The machine according to claim 7, wherein the expelling pistons (37) are coupled to the support slide (34) in a sliding manner through the interposition of respective shock absorber devices (38).

9. The machine according to claim 1 and further comprising a feeding drum (4) having a feeding disc (5), which is mounted so as to rotate in an intermittent manner around a second rotation axis (6) substantially parallel to the first rotation axis (12), extends under the dosing disc (11) in the area of the expulsion station (24), and is provided with at least a group (7) of pockets (8), each suited to receive and hold a respective capsule (2).

10. The machine according to claim 1, wherein the dosing drum (10) is further provided with at least one distribution member (22) to distribute the product (18) along an annular peripheral portion of the dosing disc (11).

11. A method for filling capsules (2) with pharmaceutical or nutraceutical products in an intermittent rotary machine comprising a dosing drum (10) comprising, in turn, a dosing disc (11), which is mounted so as to rotate in an intermittent manner around a substantially vertical first rotation axis (12) and is provided with at least a group (15) of dosing chambers (16) obtained through the dosing disc (11) parallel to the first rotation axis (12); a hopper (17) for containing a pharmaceutical or nutraceutical powder product (18), which is delimited at the bottom by the dosing disc (11); at least one compacting station (23), which is provided with a plurality of compacting pistons (31), each associated with a respective dosing chamber (16); and an expulsion station (24), which is provided with a plurality of expelling pistons (37), each associated with a respective dosing chamber (16);
the method comprising the step of:
moving each compacting piston (31) along the respective dosing chamber (16) so as to compact the product (18) contained in the dosing chamber (16);
and being characterized in that it further comprises the step of:
moving each expelling piston (37) along part of the respective dosing chamber (16) so as to discharge into the respective capsule (2) only part of the product (18) contained in the dosing chamber (16).

12. The method according to claim 11, wherein each dosing chamber (16) houses, on the inside, in the area of the expulsion chamber (24), a first and a second portion (18a, 18b) of product (18); each expelling piston (37) being moved along the respective dosing chamber (16) so as to discharge the first portion (18a) into the respective capsule (2) and hold the second portion (18b) in the dosing chamber (16).

13. The method according to claim 12, wherein the machine further comprises a feeding drum (4) comprising, in turn, a feeding disc (5), which is mounted so as to rotate in an intermittent manner around a second rotation axis (6) substantially parallel to the first rotation axis (12), extends under the dosing disc (11), and is provided with a plurality of pockets (8), each suited to receive and hold a respective capsule (2); the method further comprising the step of:
moving the dosing disc (11) and the feeding disc (5) relative to one another around said first and said second rotation axis (6, 12) so as to separate the first portion (18a) of product (18) from the second portion (18b) of product (18).

14. The method according to claim 12 and further comprising the step of:
adjusting the position of each expelling piston (37) relative to the dosing disc (11) parallel to the first rotation axis (12), so as to selectively control the first portion (18a) of product (18).

15. The method according to claim 12 and further comprising the step of:
filling each dosing chamber (16), downstream of the expulsion station (24), starting from the second portion (18b) of product (18).

16. The method according to claim 11 and further comprising the steps of:
closing the dosing chambers (16) at the bottom in the area of the compacting stations (23); and
opening the dosing chambers (16) at the bottom in the area of the expulsion station (24).
